(19) United States
(12) Patent Application Publication
(10) Pub. No.: US 2026/0253897 A1
(43) Pub. Date: Aug. 27, 2026

(54) BATTERY ELECTRODE AND METHOD OF MAKING THE SAME

(71) Applicant: SYENSQO SPECIALTY POLYMERS ITALY S.p.A., Bollate (IT)

(72) Inventors: Rong Er Lin, Shanghai (CN); Francesco Liberale, Bollate (IT); Maurizio Biso, Bollate (IT); Riccardo Rino Pieri, Bollate (IT)

(73) Assignee: SYENSQO SPECIALTY POLYMERS ITALY S.p.A., Bollate (IT)

(21) Appl. No.: 19/163,355

(22) PCT Filed: Mar. 6, 2024
(86) PCT No.: PCT/EP2024/055772

§ 371 Date: Sep. 8, 2025

(30) Foreign Application Priority Data
Mar. 9, 2023 (EP) 23160872.0

(51) Int. Cl. H01M 4/62; H01M 4/02; H01M 4/04; H01M 4/136; H01M 4/1397; H01M 4/58; H01M 10/0525

(52) U.S. Cl. CPC H01M 4/623; H01M 4/0404; H01M 4/0471; H01M 4/136; H01M 4/1397; H01M 4/5825; H01M 10/0525; H01M 2004/028

(57) ABSTRACT

The present invention pertains to a binder for a secondary battery positive electrode, to a method of preparation of said electrode and to its use in a secondary battery. The invention also relates to the secondary batteries manufactured by incorporating said electrode.

### CROSS REFERENCE TO PREVIOUS APPLICATIONS

This application claims priority to European application No. 23160872.0 filed on 9 Mar. 2023, the whole content of this application being incorporated herein by reference for all purposes.

### TECHNICAL FIELD

The present invention pertains to a binder for a secondary battery positive electrode, to a method of preparation of said electrode and to its use in a secondary battery.

The invention also relates to the secondary batteries manufactured by incorporating said electrode.

### BACKGROUND ART

Electrochemical devices such as secondary batteries typically comprise a positive electrode, a negative electrode and an electrolyte.

The electrodes for lithium batteries are usually produced by mixing a binder with a powdery electrode active material.

Fluororesins such as vinylidene fluoride-based polymers have been used as binders for forming positive electrodes. In particular, polyvinylidene fluoride (PVDF) provides a good electrochemical stability and high adhesion to the electrode materials. PVDF is therefore a preferred binder material for electrode slurries.

US 2018/0355206 discloses the use of a copolymer of methyl methacrylate and methacrylic acid in admixture with PVDF for the preparation of LiNMC electrode slurries having good adhesion to the current collector; said mixture has a viscosity that makes it possible to easily spread the active substance over the metal current collector, thus facilitating the manufacture of an electrode for a lithium ion battery.

US 2015/0280238 discloses a stable electrode binder dispersion for use in the preparation of LFP cathodes for lithium ion battery, said dispersion comprising a PVDF dispersed in an organic diluent and a (meth)acrylic polymer dispersant.

The solutions currently available in this field rely on the use of PVDF homopolymers-based binders, which however suffer from poor adhesion to current collectors.

Modified polar PVDF polymers, such as those comprising recurring units derived from hydrophilic (meth)acrylic monomers (e.g. acrylic acid), are well known in the art. Such copolymers have been developed aiming at adding to the mechanical properties and chemical inertness of PVDF suitable adhesion towards metals, e.g. aluminium or copper.

However, modified polar PVDF polymers when used in the preparation of a slurry for forming positive electrodes with certain active materials. In particular, in lithium ion batteries, when LiFePO₄ (LFP) active material is used, an important drawback is that the slurry often undergoes to a rapid viscosity increase, leading to the formation of a gel, thus preventing their use as binder for LPF cathodes.

A time dependency in the rheological properties of the composite electrode slurries is observed also in sodium-ion secondary batteries; in fact, gelation of the slurry can be initiated by the NaOH present on the material when exposed to air, with consequent dehydrofluorination with crosslinking of PVDF. Said gelation leads to inhomogeneous coatings being produced.

The need for more performing polymers, which guarantee in particular better mechanical performance and higher adhesion to current collectors, is still felt both in research and from industrial perspectives.

One way is to find a blend of polymers which therefore avoids the drawbacks of PVDF homopolymer and of modified polar PVDF polymers in contact with certain active materials such as LFP, but which at the same time guarantees the feasibility of electrodes through wet casting and high adhesions of the final product.

### SUMMARY OF INVENTION

It is thus an object of the invention a positive electrode-forming composition (C) comprising:
a) at least one positive electrode active material (AM);
b) one binder (B), wherein binder (B) comprises:
   i) at least one vinylidene fluoride (VDF) copolymer [polymer (F)] that comprises:
(ia) recurring units derived from VDF;
(ib) optionally, recurring units derived from at least one hydrophilic vinyl monomer (MA) of formula (I):

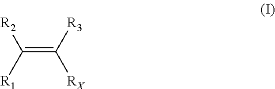

wherein:
R₁, R₂ and R₃, equal to or different from each other, are independently selected from a hydrogen atom and a C₁-C₃ hydrocarbon group, and
R_{X} is a C₁-C₂₀ hydrocarbon moiety comprising at least one functional group selected from a hydroxyl, a carboxyl, an epoxide, an ester, a phosphate and an ether group,
in an amount of from 0.05 to 10% by moles of with respect to the total moles of recurring units of polymer (F);
   ii) at least one polymer [polymer (A)] derived from the polymerization of at least one monomer (1) and of at least one monomer (II), the said monomers corresponding to the following:
monomer (I): ethylenically unsaturated, linear or branched, aliphatic, cyclic or aromatic polycarboxylic acid, or anhydride,
monomer (II): ethylenically unsaturated, linear or branched aliphatic, cyclic or aromatic hydrocarbon;
c) at least one solvent (S); and
d) optionally at least one electroconductivity-imparting additive.

In a second instance, the present invention pertains to the use of the electrode-forming composition (C) of the invention in a process for the manufacture of a positive electrode for electrochemical devices [electrode (E)], said process comprising:
(i) providing a metal substrate having at least one surface;
(ii) providing an electrode-forming composition (C) as defined above:
(iii) applying the composition (C) onto the at least one surface of the metal substrate, thereby providing an assembly comprising a metal substrate coated with said composition (C) onto the at least one surface;
(iv) drying the assembly provided in step (iii).

In a third instance, the present invention pertains to the positive electrode (E) obtainable by the process of the invention.

In a fourth instance, the present invention pertains to an electrochemical device comprising a positive electrode (E) of the present invention.

### DESCRIPTION OF EMBODIMENTS

In the context of the present invention, the use of parentheses “( . . . )” before and after symbols or numbers identifying formulae or parts of formulae has the mere purpose of better distinguishing that symbol or number with respect to the rest of the text; thus, said parentheses could also be omitted.

The terms “acrylic” and “acrylate” are used interchangeably (unless to do so would alter the intended meaning) and include acrylic acids and derivatives thereof. The terms “(meth)acrylic” or “(meth)acrylate” are intended to cover both the acrylic/acrylate and methacrylic/methacrylate forms of the indicated material, e.g., a (meth)acrylate monomer.

The electrode active material (AM) of the positive electrode is preferably a compound capable of intercalating lithium ions or sodium ions.

The conventional active materials (AM) at the positive electrode of sodium-ion batteries are generally selected from Na-based layered transition-metal oxides, Prussian blue analogs and polyanion-type materials.

In some embodiments the active materials are Na-based layered transition-metal oxides classified as O3-, P2-, and P3-types depending on the stacking sequence of oxygen layers. P2-type structures generally respond to the general formula NaxMO₂ wherein M stands for a transition metal ion such as Co, Mn and x is ⅔.

In some embodiments the active materials are Prussian blue analogs (PBA) of general formula AₓP[R(CN)₆]_{1-y□y}·mH₂O with A and alkali metal ion, P a N-coordinated transition metal ion, R a C-coordinated transition metal ion, □ a [R(CN)₆] vacancy, with 0≤x≤2 and 0≤y<1 such as Na_{0.81}Fe[Fe(CN)₆]_{0.79□0.21}, NaFe₂(CN)₆, Na_{1.63}Fe_{1.89}(CN)₆, Na_{1.72}MnFe(CN)₆, Na_{1.76}Ni_{0.12}Mn_{0.88}[Fe(CN)₆]_{0.98}, Na₂NiₓCo₁₋ₓFe(CN)₆ with 0≤x≤1 e.g. Na₂CoFe(CN)₆.

In some other embodiments the active materials are polyanion-type materials of general formula NaₓM_{y}(XO₄)ₙ (where X=S, P, Si, As, Mo and W and M is transition metal), which possess a series of tetrahedron anion units (XO₄)ⁿ⁻ and their derivatives (XₘO₃ₘ₊₁)ⁿ⁻. Among them, phosphates NaMPO₄ such as NaFePO₄, Na_{0.7}FePO₄ or NaMnPO₄; natrium (sodium) superionic conductor of NASICON-type structures of general formula NaₓM₂(XO₄)₃ (where 1≤x≤4 and M=V, Fe, Ni, Mn, Ti, Cr, Zr . . . ; X=P, S, Si, Se, Mo . . . )—with single transition metal type such as Na₃V₂(PO₄)₃ (NVP), Na₃Cr₂(PO₄)₃, Na₃Fe₂(PO₄)₃; —with binary transition metal type such as Na₂VTi(PO₄)₃, Na₃FeV(PO₄)₃, Na₄MnV(PO₄)₃, Na₃MnZr(PO₄)₃, Na₃MnTi(PO₄)₃, Na₄Fe₃(PO₄)₂(P₂O₇) (NFPP); pyrophosphates Na₂FeP₂O₇, Na₂MnP₂O₇, Na₂CoP₂O₇, Na₄₋ₓFe_{2+x/2}(P₂O₇)₂ with ⅔≤x≤⅞ e.g. Na_{3.12}Fe_{2.44}(P₂O₇)₂ or Na_{3.32}Fe_{2.34}(P₂O₇)₂, Na₂(VO)P₂O₇, Na₇V₃(P₂O₇)₄; fluorophosphates NaVPO₄F, Na₂CoPO₄F, Na₂FePO₄F, Na₂MnPO₄F, Na₃(VO₁₋ₓPO₄)₂F₁₊₂ₓ (with 0≤x≤1) e.g. Na₃(VOPO₄)₂F or Na₃V₂(PO₄)₂F₃ (NVPF); fluoro sulfates such as NaMSO₄F (with M=Fe, Co, Ni); mixed phosphates/pyrophosphates of general formula Na₄M₃(PO₄)₂(P₂O₇) (with M representing transition metals) such as Na₄Mn₃(PO₄)₂(P₂O₇), Na₄Co₃(PO₄)₂(P₂O₇), Na₄Ni₃(PO₄)₂(P₂O₇), Na₄Fe₃(PO₄)₂(P₂O₇) (NFPP), Na₇V₄(P₂O₇)₄(PO₄); sulfates such as Na₂Fe₂(SO₄)₃, Na₂₊₂ₓFe₂₋ₓ(SO₄)₃, Na₂₊₂ₓCo₂₋ₓ(SO₄)₃, Na₂₊₂ₓMn₂₋ₓ(SO₄)₃ (where 0≤x≤1); silicates of general formula Na₂MSiO₄ (with M=Mn, Fe, Co and Ni).

In some preferred embodiments the active materials are fluorophosphates preferably selected from the list consisting of NaVPO₄F, Na₂CoPO₄F, Na₂FePO₄F, Na₂MnPO₄F, Na₃(VO₁₋ₓPO₄)₂F₁₊₂ₓ (with 0≤x≤1) e.g. Na₃(VOPO₄)₂F or Na₃V₂(PO₄)₂F₃ (NVPF).

The conventional active materials (AM) at the positive electrode of lithium-ion batteries may comprise a composite metal chalcogenide of formula LiMQ₂, wherein M is at least one metal selected from transition metals such as Co, Ni, Fe, Mn, Cr and V and Q is a chalcogen such as O or S. Among these, it is preferred to use a lithium-based composite metal oxide of formula LiMO₂, wherein M is the same as defined above. Preferred examples thereof may include LiCoO₂, LiNiO₂, LiNiₓCo₁₋ₓO₂ (0<x<1) and spinel-structured LiMn₂O₄.

As an alternative, still, the electrode active material may comprise a lithiated or partially lithiated transition metal oxyanion-based electro-active material of formula M₁M₂(JO₄)_{f}E_{1-f}, wherein M₁ is lithium, which may be partially substituted by another alkali metal representing less than 20% of the M₁ metals, M₂ is a transition metal at the oxidation level of +2 selected from Fe, Mn, Ni or mixtures thereof, which may be partially substituted by one or more additional metals at oxidation levels between +1 and +5 and representing less than 35% of the M₂ metals, including 0, JO₄ is any oxyanion wherein J is either P, S, V, Si, Nb, Mo or a combination thereof, E is a fluoride, hydroxide or chloride anion, f is the molar fraction of the JO₄ oxyanion, generally comprised between 0.75 and 1.

The M₁M₂(JO₄)_{f}E_{1-f} electro-active material as defined above is preferably phosphate-based and may have an ordered or modified olivine structure.

More preferably, the electrode active material has formula Li₃₋ₓM′_{y}M″_{2-y}(JO₄)₃ wherein 0≤x≤3, 0≤y≤2, M′ and M″ are the same or different metals, at least one of which being a transition metal, JO₄ is preferably PO₄ which may be partially substituted with another oxyanion, wherein J is either S, V, Si, Nb, Mo or a combination thereof. Still more preferably, the electrode active material (AM) is a phosphate-based electro-active material of formula LiₓA_{y}D_{z}PO₄,
wherein A is selected from the group consisting of Mn, Fe, Co, Ni and Cu; D is selected from the group consisting of Mg, Ca, Sr, Ba; x, y and z are numbers that satisfy the following relationships: 0<x<2, 0<y<1.5, 0≤z<1.5.

The A component is preferably Fe, Mn, and Ni, and particularly preferably Fe.

The D component is preferably Mg or Ca.

Examples of the compound having an olivine structure include lithium iron phosphate (LFP), lithium iron manganese phosphate (LMFP) and lithium manganese phosphate.

Further, as the positive electrode active material (AM), it is possible to use a material whose surface is partially or wholly covered with carbon in order to supplement the conductivity.

The amount of carbon coated is preferably 20 parts by weight or less, more preferably 10 parts by weight or less, still more preferably 5 parts by weight or less, based on 100 parts by weight of the positive electrode active material.

The compound having an olivine structure is present in composition (C) in an amount of 70% by mass or more, with respect to 100% by mass of the entire positive electrode active material (AM).

More preferably, it is 90% by mass or more, and most preferably, the positive electrode active material (AM) is composed only of a compound having an olivine structure.

Most preferably, the positive electrode active material (AM) consists only of lithium iron phosphate (LFP).

In the positive electrode composition of the present invention, the active material (AM) has an average particle size of 3 μm or less.

The average particle size (D50) of the compound having an olivine structure is more preferably in the range of from 0.01 to 1.8 μm.

The average particle size of the positive electrode active material can be measured by a particle size distribution meter for dynamic light scattering.

As the average particle size becomes smaller, the surface area becomes larger and the binder must be bound with a small amount of the binder, so that the flexibility of the binder is required.

By using a positive electrode active material containing a compound having an olivine structure having an average particle size of 3 μm or less, the electrical characteristics such as the output characteristics when the positive electrode composition for a secondary battery is used as the positive electrode of the battery are excellent.

Composition (C) of the invention comprises a binder (B) comprising:
i) at least one vinylidene fluoride (VDF) copolymer [polymer (F)] as above defined; and
ii) at least one polymer (A) as above defined.

The polymer (F) comprises recurring units derived from vinylidene fluoride (VDF) and recurring units derived from at least one hydrophilic vinyl monomer (MA) of formula (I):

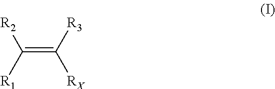

wherein:
   R₁, R₂ and R₃, equal to or different from each other, are independently selected from a hydrogen atom and a C₁-C₃ hydrocarbon group, and
   R_{X} is a C₁-C₂₀ hydrocarbon moiety comprising at least one functional group selected from a hydroxyl, a carboxyl, an epoxide, an ester, a phosphate and an ether group,
in an amount of from 0.05 to 10% by moles of with respect to the total moles of recurring units of polymer (F).

The term “hydrophilic vinyl monomer” as employed herein may comprise recurring units derived from one or more than one hydrophilic (meth)acrylic monomer (MA) as above described. In the rest of the text, the expressions “hydrophilic vinyl monomer (MA)” is to be intended, both in the plural and the singular, that is to say that they denote both one or more than one hydrophilic vinyl monomer (MA).

More preferably, the hydrophilic vinyl monomer (MA) preferably complies with formula (II):

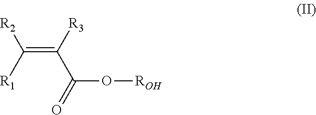

wherein each of R₁ and R₂ have the meanings as above defined, R3 is hydrogen, and R_{OH} is a hydrogen or a C₁-C₅ hydrocarbon moiety comprising at least one hydroxyl group and/or at least a carboxylic group, more preferably, each of R₁, R₂, R₃ are hydrogen, while R_{OH} has the same meaning as above detailed.

Non limitative examples of hydrophilic vinyl monomers (MA) are notably acrylic acid, methacrylic acid, hydroxyethyl (meth)acrylate, hydroxypropyl(meth)acrylate, hydroxyethylhexyl(meth)acrylates.

The monomer (MA) is more preferably selected among:
hydroxyethylacrylate (HEA) of formula:

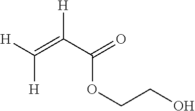

2-hydroxypropyl acrylate (HPA) of either of formulae:

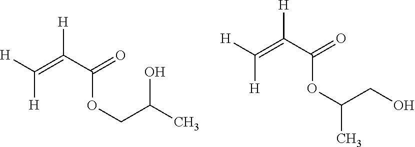

acrylic acid (AA) of formula:

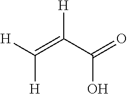

and mixtures thereof.

Most preferably, the monomer (MA) is AA and/or HEA.

Polymer (F) may still comprise other moieties such as defects, end-groups and the like, which do not affect nor impair its physico-chemical properties.

Polymer (F) is semi-crystalline. The term semi-crystalline is intended to denote a polymer (F) which possesses a detectable melting point. It is generally understood that a semi-crystalline polymer (F) possesses a heat of fusion determined according to ASTM D 3418 of advantageously at least 0.4 J/g, preferably of at least 0.5 J/g, more preferably of at least 1 J/g.

Polymer (F) is preferably a linear copolymer, that is to say, it is composed of macromolecules made of substantially linear sequences of recurring units from VDF monomer and (MA) monomer; polymer (F) is thus distinguishable from grafted and/or comb-like polymers.

Polymer (F) comprises at least 0.05% by moles, more preferably at least 0.1% by moles, even more preferably at least 0.2% by moles of recurring units derived from said hydrophilic (meth)acrylic monomer (MA).

Polymer (F) comprises preferably at most 2% by moles, more preferably at most 1.8% by moles, even more preferably at most 1.5% by moles of recurring units derived from said hydrophilic vinyl monomer (MA).

In a preferred embodiment of the invention, in polymer (F) the recurring units derived from hydrophilic vinyl monomer (MA) of formula (I) are comprised in an amount of from 0.2 to 1% by moles with respect to the total moles of recurring units of polymer (F).

The polymer (F) has advantageously an intrinsic viscosity, measured in dimethylformamide at 25° C., of above 0.15 I/g and at most 0.60 l/g, preferably in the range of 0.20-0.50 I/g, more preferably comprised in the range of 0.25-0.40 l/g.

The polymer (F) may further comprise recurring units derived from one or more fluorinated comonomers (CF) different from VDF.

By the term “fluorinated comonomer (CF)”, it is hereby intended to denote an ethylenically unsaturated comonomer comprising at least one fluorine atoms.

Non-limitative examples of suitable fluorinated comonomers (CF) include, notably, the followings:
(a) C₂-C₈ fluoro- and/or perfluoroolefins such as tetrafluoroethylene (TFE), hexafluoropropylene (HFP), pentafluoropropylene and hexafluoroisobutylene;
(b) C₂-C₈ hydrogenated monofluoroolefins, such as vinyl fluoride; 1,2-difluoroethylene and trifluoroethylene;
(c) perfluoroalkylethylenes of formula CH₂═CH—R_{f0}, wherein R_{f0} is a C₁-C₆ perfluoroalkyl group;
(d) chloro- and/or bromo- and/or iodo-C₂-C₆ fluoroolefins such as chlorotrifluoroethylene (CTFE).

In one embodiment of the invention, polymer (F) comprises from 0.1 to 10.0% by moles, preferably from 0.3 to 5.0% by moles, more preferably from 0.5 to 3.0% by moles of recurring units derived from said fluorinated comonomer (CF).

The polymer (F) more preferably comprises recurring units derived from:
at least 70% by moles, preferably at least 75% by moles, more preferably at least 85% by moles of vinylidene fluoride (VDF),
from 0.2% to 1% by moles, of a hydrophilic (meth)acrylic monomer (MA) of formula (I);
optionally from 0.5 to 3.0% by moles of recurring units derived from at least one fluorinated comonomer (CF).

The polymer (F) may be obtained by polymerization of a VDF monomer, at least one monomer (MA) and optionally at least one comonomer (CF), either in suspension in organic medium, according to the procedures described, for example, in WO 2008/129041, or in aqueous emulsion, typically carried out as described in the art (see e.g. U.S. Pat. Nos. 4,016,345, 4,725,644 and 6,479,591).

The procedure for preparing the polymer (F) in suspension comprises polymerizing in an aqueous medium in the presence of a radical initiator the vinylidene fluoride (VDF) monomer, monomer (MA) and optionally comonomer (CF), in a reaction vessel, said process comprising
continuously feeding an aqueous solution comprising monomer (MA); and
maintaining the pressure in said reactor vessel exceeding the critical pressure of the vinylidene fluoride.

During the whole suspension polymerization run, pressure is maintained above critical pressure of vinylidene fluoride. Generally, the pressure is maintained at a value of more than 50 bars, preferably of more than 75 bars, even more preferably of more than 100 bars.

The expressions “continuous feeding”, “adding continuously” or “continuously feeding” means that slow, small, incremental additions the aqueous solution of hydrophilic vinyl monomer (MA) take place until polymerization has concluded.

The polymer (F) thus obtained has a high uniformity of monomer (MA) distribution in the polymer backbone, which advantageously maximizes the effects of the modifying monomer (MA) on both adhesiveness and/or hydrophilic behaviour of the resulting copolymer.

In addition, the Applicant has surprisingly found that the presence of the monomer (MA) uniformly distributed in the polymer (F) has the effect of improving the thermal stability of VDF copolymers, which otherwise is unsatisfactorily low, in particular lower than that of VDF homopolymers.

Polymer (A) is a copolymer derived from the polymerization of at least one monomer (I) and of at least one monomer (II), wherein
monomer (I): ethylenically unsaturated, linear or branched, aliphatic, cyclic or aromatic polycarboxylic acid, or anhydride,
monomer (II): ethylenically unsaturated, linear or branched aliphatic, cyclic or aromatic hydrocarbon monomer.

By “copolymer” as used herein it is intended to denote a polymer having two or more different monomer units. The copolymer could be a terpolymer with three or more different monomer units, or have four or more different monomer units. The copolymer may be a random copolymer, a gradient copolymer, or a block copolymer formed by a controlled polymerization process. Preferably, the copolymer is formed by a free radical polymerization process or an anionic polymerization process, and the process can be any polymerization method known in the art, including but not limited to solution, suspension polymerization, and can be done in bulk, and semi-bulk.

The monomer (1) is preferably a monomer of the following formula:

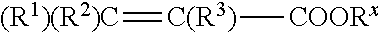

wherein the radicals R¹, R² and R³, which are identical or different, are selected from the group consisting of a hydrogen atom, a C₁-C₁₀ hydrocarbon radical optionally comprising a —COOH group, and a —COOH group, wherein at least one of R¹, R² and R³ is not a hydrogen atom;
R_{X} is selected from a hydrogen atom or a C₁-C₂₀ hydrocarbon moiety comprising at least one carboxyl functional group, wherein the —COOH group of any of R¹ and R² can optionally be at least in part taken together with the group COOR^{X} to form an anhydride.

According to a preferred embodiment of the invention, the monomer (I) is a a polycarboxylic acid or a carboxylic anhydride corresponding to the following formula:

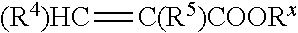

wherein: R⁴ is selected from the group consisting of a hydrogen atom, a —COOH group or a —(CH₂)ₙ—COOH group in which n is between 1 and 4, or a C₁-C₄alkyl radical;
R⁵ is selected from the group consisting of a hydrogen atom, a —(CH₂)ₘ—COOH group in which m is between 1 and 4, or a C₁-C₄alkyl radical; wherein at least one of R⁴ and R⁵ is not a hydrogen atom;
R^{X} is as above defined.

Preferably, R⁴ is selected from the group consisting of a hydrogen atom, a group —COOH or (CH₂)—COOH, a methyl radical, and R⁵ is selected from the group consisting of a hydrogen atom, a group —CH₂COOH or a methyl radical, wherein at least one of R⁴ and R⁵ is not a hydrogen atom.

According to a more specific embodiment, the monomer (1) is selected from the group consisting of: citraconic, maleic, fumaric or itaconic, acids, esters or anhydrides; (meth) acryloyloxyalkyl succinic acid, such as (meth) acryloyloxyethyl succinic acid and (meth) acryloyloxypropyl succinic acid.

Still more preferably, monomer (1) is maleic anhydride.

The monomer (II) is preferably a monomer of the following formula:

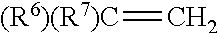

wherein the radicals R⁶ and R⁷, which are identical or different, are selected from the group consisting of a hydrogen atom or a linear or branched, aliphatic, or cyclic, saturated or ethylenically unsaturated C₁-C₁₀ radical.

More particularly, the said radicals R⁶ and R⁷, which are identical or different, are selected from the group consisting of a hydrogen atom or a saturated, linear or branched aliphatic, or cyclic, C₁-C₁₀ radical.

Preferably, the said monomer (II) is selected from the group consisting of: ethylene, propylene, 1-butene, isobutylene, n-1-pentene, 2-methyl-1-butene, n-1-hexene, 2-methyl-1-pentene, 4-methyl-1-pentene, 2-ethyl-1-butene, di-isobutylene (or 2,4,4-trimethyl-1-pentene), 2-methyl-3,3-dimethyl-1-pentene.

In one embodiment of the present application, polymer (A) is preferably a copolymer of maleic anhydride and di-isobutylene.

In one embodiment, the polymer (A) is more particularly a copolymer of 40% to 60% by moles of monomer (I) and 60% to 40% by moles of monomer (II).

In a preferred embodiment of the present invention, polymer (A) is a copolymer of maleic anhydride and di-isobutylene that contains about 40% to 60% by moles, preferably about 50% by moles of maleic anhydride monomer units and 60% to 40% by moles, preferably about 50% by moles of di-isobutylene monomer units.

The molecular weight Mw of the copolymer used as polymer (A) is generally between 10 000 Da and 500 000 Da, preferably between 15 000 Da and 75 000 Da.

The polymer (A) is prepared by polymerizing a mixture of monomer (I) and monomer (II), optionally in the presence of other alpha, beta-ethylenically unsaturated monomers, such as acrylonitrile, N-vinylimidazole, N-vinylpyrrolidone, vinylphosphonic acid.

The polymer (A) may further be at least partially neutralized to obtain at least a fraction of the anhydride or carboxylic acid moieties in the form of a salt.

In an embodiment of the present invention, it is thus provided a binder (B) comprising a polymer (A) that is at least partially salified.

The preparation of polymer (A) may thus further include a step of neutralization of at least a fraction of anhydride or carboxyl groups with a salt [salt (SA)] including a monovalent or a divalent cation in a suitable solvent.

The salt (SA) can be any salt capable of neutralizing the anhydride or carboxylic acid groups, and it is preferably selected from a salt capable of providing an alkali metal cation, an alkaline earth metal cation, a tertiary or quaternary ammonium cation, more preferably Na⁺, K⁺, Li⁺ and or quaternary ammonium cation.

The choice of the solvent (S) is not particularly limited, provided that it is suitable for solubilising polymer (F) and dispersing/dissolving polymer (A).

Solvent (S) is typically selected from the group consisting of:
alcohols such as methyl alcohol, ethyl alcohol and diacetone alcohol,
ketones such as acetone, methylethylketone, methylisobutyl ketone, diisobutylketone, cyclohexanone and isophorone,
linear or cyclic esters such as isopropyl acetate, n-butyl acetate, methyl acetoacetate, dimethyl phthalate and γ-butyrolactone,
linear or cyclic amides such as N,N-diethylacetamide, N,N-dimethylacetamide, dimethylformamide and N-methyl-2-pyrrolidone, and
dimethyl sulfoxide.

The electrode forming compositions of the present invention may further include one or more optional electroconductivity-imparting additives in order to improve the conductivity of an electrode made from the composition of the present invention. Electroconductivity-imparting additives for batteries are known in the art.

Examples thereof may include: carbonaceous materials, such as carbon black, graphite fine powder carbon nanotubes, graphene, or fiber, or fine powder or fibers of metals such as nickel or aluminum. The optional conductive agents are preferably carbon black or carbon nanotubes.

The amount of optional conductive agent is preferably from 0 to 30% by weight with respect to the total solids in the electrode forming composition.

In particular, for positive electrode forming compositions the optional conductive agent is typically from 0% by weight to 10% by weight, more preferably from 0% by weight to 5% by weight of the total amount of the solids within the composition (C).

Composition (C) may further comprise at least one wetting agent and/or at least one surfactant and one or more than one additional additives.

Composition (C) may further comprise at least one non-electroactive inorganic filler material.

By the term “non-electroactive inorganic filler material”, it is hereby intended to denote an electrically non-conducting inorganic filler material, which is suitable for the manufacture of an electrically insulating separator for electrochemical cells.

The non-electroactive inorganic filler material in the separator according to the invention typically has an electrical resistivity (p) of at least 0.1×1010 ohm cm, preferably of at least 0.1×1012 ohm cm, as measured at 20° C. according to ASTM D 257.

Non-limitative examples of suitable non-electroactive inorganic filler materials include, notably, natural and synthetic silicas, zeolites, aluminas, titanias, metal carbonates, zirconias, silicon phosphates and silicates and the like.

Binder (B) for use in the composition (C) according to the present invention can be prepared by any known method in the art.

A suitable method comprises:
dissolving polymer (F) with a solvent (S),
adding polymer (A) in the form of powder or alternatively as dispersed/dissolved in solvent (S),
mixing to provide a binder mixture (B).

The weight ratio of polymer (F) to polymer (A) in binder (B) is conveniently in the range of from 95:5 to 70:30. In a preferred embodiment of the invention, the weight ratio of polymer (F) to polymer (A) in binder (B) is 90:10.

The electrode-forming composition (C) may be obtained by adding and dispersing a powdery electrode material, and optional additives, such as an electroconductivity-imparting additive and/or a viscosity modifying agent, into the thus-obtained binder mixture (B), to obtain a homogeneous slurry.

The solution of polymer (F) in solvent (S) is notably comprising the polymer (F) in an amount of from 5 to 20% by weight, preferably about 7 to 10% by weight.

When polymer (A) is added as a dispersion or solution in solvent (S), the amount of polymer (A) in solvent (S) is notably comprised in a range of from 0.1 to 15% by weight in 100 parts by weight of such a solvent.

In order to prepare the binder mixture (B), it is preferred to first dissolve the polymer (F) in a solvent (S) and dispersing or dissolving polymer (A) in solvent (S) at a temperature of 20 to 50° C.

Alternatively, the binder solution (B) can be prepared by first dissolving polymer (F) in solvent (S), followed by addition of solid polymer (A) to the mixture prepared thereof.

The total solid content (TSC) of the composition (C) of the present invention is typically comprised between 15 and 70% by weight, preferably from 40 to 60% by weight over the total weight of the composition (C). The total solid content of the composition (C) is understood to be cumulative of all non-volatile ingredients thereof, notably including polymer (F), polymer (A), the electrode active material and any solid, non-volatile additional additive.

When the solution of polymer (F) is combined with polymer (A), with an electrode active material and with the optional conductive material and other additives to prepare composition (C), an amount of solvent sufficient to create a stable solution of polymer (F) is employed. The amount of solvent used may range from the minimum amount needed to create a stable solution of polymer (F) to an amount needed to achieve a desired total solid content in an electrode mixture after the polymer (A), the active electrode material, the optional conductive material, and the other solid additives have been added.

The presence of polymer (A) in the composition (C) makes it possible to obtain homogenous slurry compositions with no gelation evidence in all the preparation steps. Thus, it is possible to use of polymers (F) bearing polar groups in electrode-forming composition comprising the olivine type active material electrodes, and exploiting the properties of such polymers in electrodes, such as the greater adhesion to current collector, the improved flexibility and the good mechanical performances.

In addition, polymer (A) acts as a dispersant in binder compositions, and reduces the slurry viscosity versus compositions having the same TSC but comprising a polymer (F), an active material and an electroconductivity-imparting additive only.

Another advantage of the composition (C) of the present invention is that it is possible to provide an electrode which comprises a relatively low content by weight of binder and to make it possible to increase the content of active material in the positive electrode, in order to maximise the capacity of the battery.

The electrode-forming composition (C) of the invention can be used in a process for the manufacture of a positive electrode [electrode (E)], said process comprising:
(i) providing a metal substrate having at least one surface;
(ii) providing an electrode-forming composition [composition (C)] as above defined;
(iii) applying the composition (C) onto the at least one surface of the metal substrate, thereby providing an assembly comprising a metal substrate coated with said composition (C) onto the at least one surface;
(iv) drying the assembly provided in step (iii).

The metal substrate is generally a foil, mesh or net made from a metal, such as from aluminium, nickel, titanium, and alloys thereof.

In step (iii) of the process of the invention, the electrode forming composition (C) is applied onto at least one surface of the metal substrate typically by any suitable procedures such as casting, printing and roll coating.

Optionally, step (iii) may be repeated, typically one or more times, by applying the electrode forming composition (C) provided in step (ii) onto the assembly provided in step (iv).

In step (iv) of the process of the invention, drying may be performed either under atmospheric pressure or under vacuum. Alternatively, drying may be performed under modified atmosphere, e.g. under an inert gas, typically exempt notably from moisture (water vapour content of less than 0.001% v/v).

The drying temperature will be selected so as to effect removal by evaporation of the aqueous medium from the electrode (E) of the invention.

The dried assembly obtained in step (iv) may further be submitted to a compression step such as a calendaring process, to achieve the target porosity and density of the electrode (E) of the invention.

Preferably, the dried assembly obtained at step (iv) is hot pressed, the temperature during the compression step being comprised from 25° C. and 130° C., preferably being of about 60° C.

Preferred target density for electrode (E) is comprised between 2 and 3 g/cc, preferably at least 2.1 g/cc. The density of electrode (E) is calculated as the sum of the product of the densities of the components of the electrode multiplied by their mass ratio in the electrode formulation.

In a further aspect, the present invention pertains to the positive electrode [electrode (E)] obtainable by the process of the invention.

Therefore the present invention relates to a positive electrode (E) comprising:
a metal substrate having at least one surface, and
directly adhered onto at least one surface of said metal substrate, at least one layer consisting of a composition [composition (C′)] comprising:
a) at least one positive electrode active material (AM);
b) a binder composition [binder (B′)] comprising:
b′) at least one polymer (F) as above defined,
b″) at least one polymer (A) as above defined;
c) optionally, at least one electroconductivity-imparting additive.

The composition (C′) directly adhered onto at least one surface of said metal substrate corresponds to the electrode forming composition (C) of the invention wherein the solvent has been at least partially removed during the manufacturing process of the electrode, for example in step (iv) (drying) and/or in the further compression step.

Therefore all the preferred embodiments described in relation to the electrode forming compositions (C) of the invention are also applicable to the composition (C′) directly adhered onto at least one surface of said metal substrate, in electrodes of the invention, except for the aqueous medium removed during the manufacturing process.

The preferred positive electrode (E) comprises:
a metal substrate having at least one surface, and
directly adhered onto at least one surface of said metal substrate, at least one layer consisting of:
j) a positive electrode active material (AM) in an amount from 90 to 98% by weight;
jj) the binder (B′) in an amount from 0.5 to 10% by weight, preferably from 1 to 5% by weight; and
jjj an electroconductivity-imparting additive in an amount from 0.5 to 5% by weight,
wherein the above mentioned % by weight are in respect to the total weight of j)+jj)+jjj).

Preferably, the positive electrode (E) comprises of at least 95% by weight of active material (AM) and an electrode loading comprised between 8 and 20 mg/cm², preferably of about 15 mg/cm².

The positive electrode (E) of the invention is particularly suitable for use in electrochemical devices.

By the term “electrochemical device”, it is hereby intended to denote an electrochemical cell/assembly comprising a positive electrode, a negative electrode and a liquid electrolyte, wherein a monolayer or multilayer separator is in contact to at least one surface of one of the said electrodes.

Non-limitative examples of suitable electrochemical devices include, notably, secondary batteries, especially, alkaline or an alkaline-earth secondary batteries such as lithium ion batteries, lead-acid batteries, and capacitors, especially lithium ion-based capacitors and electric double layer capacitors (supercapacitors). Non-limitative examples of electrochemical cells include, notably, batteries, preferably secondary batteries, and electric double layer capacitors.

For the purpose of the present invention, by “secondary battery” it is intended to denote a rechargeable battery. Non-limitative examples of secondary batteries include, notably, alkaline or alkaline-earth secondary batteries.

The secondary battery of the invention is more preferably a lithium-ion secondary battery.

An electrochemical device according to the present invention can be prepared by standard methods known to a person skilled in the art.

Should the disclosure of any patents, patent applications, and publications which are incorporated herein by reference conflict with the description of the present application to the extent that it may render a term unclear, the present description shall take precedence.

The invention will be now described with reference to the following examples, whose purpose is merely illustrative and not intended to limit the scope of the invention.

### EXPERIMENTAL SECTION

### Raw Materials

Polymer (F-1): VDF-AA (1.0% by moles) polymer having an intrinsic viscosity of 0.30 I/g in DMF at 25° C.
Polymer (A-1): maleic anhydride/di-isobutilene copolymer neutralized with NaOH, available from Solvay as Geropon® T36.
Nano-LFP: LFP P2/C-life C04, density: 3.34 g/cm³, practical specific capacity: 153 mAh/g, commercially available from Johnson Matthey.
Carbon nanotubes: Orgacyl NMP0402. 4% thin multiwall carbon nanotube (MWCNT) in N-Methyl-2-pyrrolidone (NMP) solvent.

### Molecular Weight Determination

The mass distribution of the polymers was measured by SEC MALS analysis (SEC: Size Exclusion Chromatography-MALLS: Multi-Angle Laser Light Scattering) in order to obtain the real values, expressed in g/mol.

The SEC MALLS analysis was performed with an HPLC chain equipped with 2 detectors:
Differential refractometer RI—the concentration detector
MALLS detector (Multi-Angle Laser Light Scattering)—the mass detector
   Ultraviolet detector UV.

For each slice of the chromatograms (for the polymeric species), the software calculates:
the concentration of the polymer, RI signal=constant*dn/dc*concentration
the mass Mi of the slice,
from particular Mi data, the software calculates the mass distribution: Mw, Mn and polydispersity index Ip=Mw/Mn.

The calculation of the molar masses requires the refractive index increment, dn/dc of the polymer. It is a constant, depending on the nature of the mobile phase, the temperature of the experimental conditions and the wavelength of the laser, among others.

The value “dn/dc” is calculated by the software according the mass recovery of the eluted fraction: for the polymers of the present invention dn/dc is 0.085 mL/g, leading from about 95 to 100% wt. mass recovery. The molar mass was calculated based on the real Mi points, without any adjustment of the log (M) curve.

Detailed Analysis conditions are as follows:
Analysis instrument: SEC system with MALLS detector (Mini Dawn TREOS); Agilent Differential Refractometer (RI) and Agilent UV detector (at 254 nm)
Pump: Agilent 1100
Mobile phase: THE with 0.01 M tetrabutylammonium tetrafluoroborate and 100 μL trifluoroacetic acid per kg of eluent
Column (maker, model no.): Agilent Polypore (2*30 cm)+guard column
Temperature: 35° C.
Flow rate: 1.0 mL/min
Injection amount and Sample concentration: 100 μL, 3 mg·mL⁻¹ in the mobile phase.

### Example 1

A 8% by weight solution of polymer (F-1) in NMP was prepared.

Polymer (A-1) in powder form was mixed with the solution of polymer (F-1) in NMP in a 9:1 ratio (29.77 g of solution of polymer (F-1) and 0.87 g of polymer (A-1)).

HSV900: PVDF homopolymer, commercially available from Arkema.

Nano-LFP (72.4 g) and carbon nanotubes (13.8 g of solution at 4.1% wt in NMP) and additional 23.8 g of NMP were added simultaneously to polymer (A-1) to the solution comprising polymer (F-1) with planetary mixing followed by dispersion phase to provide Composition 1, a cathode slurry having a Total Solid Content (TSC) of 54% (95.75% LFP, 0.75% carbon nanotubes and 3.5% binder).

A homogenous slurry was obtained, with no gelation evidence in all the preparation steps. Results of visual evaluation of slurry quality are summarized at Table 1.

### Comparative Example 1

A 8% by weight solution of HSV900 in NMP was prepared.

Nano-LFP (72.4 g), carbon nanotubes (13.8 g of solution at 4.1% wt in NMP) and additional 20.71 g of NMP were added to 33.08 g of the solution comprising HSV900 with planetary mixing followed by dispersion phase to provide Composition (C-1), a cathode slurry having a Total Solid Content (TSC) of 54% and an amount of binder of 3.5%.

Results of visual evaluation of slurry quality are summarized at Table 1.

TABLE 1

| COMPOSITION | Slurry Quality* |
|---|---|
| 1 | B |
| C-1 | A |

*A = good: visual homogeneous aspect at rest and under manual stirring. No evidence of agglomerates, nor phase separation, nor deposits on the container's walls.
B = medium: the slurry seems homogenous. Evidence of small agglomerates, e.g. solid particles not perfectly dispersed, small gels or thin deposit on the bottom or on the walls of the becker. Slurry casting not prevented.
C= bad: not homogeneous slurry, with macroscopic evidences. Gels or solid agglomerates are present. Slurry viscosity can be too high to allow casting and further mixing can be prevented/limited due to solid block (gel-like) formation. If phase separation happens, too low viscosity in the upper part and solid bottom layer.

### Example 2: Electrode-Forming Compositions Gelation Evaluation

Viscosity variation over time of Composition 1 and Composition C-1, prepared as above defined, was evaluates as follows.

The viscosity of the compositions at different aging times, up to 72 hours, was evaluated at different shear rate (from 0.1 to 100 rad/s), by comparing the values at the same share rate with an Anton Paar instrument with MCR 52 plate to plate configuration.

The Composition 1 shows excellent slurry stability over time, comparable to that of Composition C-1 from Time 0 h to Time 72 h.

### Example 3: Preparation of Electrodes

Positive electrodes were obtained by applying the electrode-forming compositions as above described to 15 μm thick aluminium foils so as to obtain a mass of dry positive electrode loading of 15 mg/cm². The solvent was completely evaporated by drying in an oven at temperature of 90° C. to fabricate a strip-shaped positive electrodes.

The positive electrodes so obtained (electrode (E1) and (EC-1), respectively) were visually evaluated. The results are reported in Table 3.

TABLE 3

| ELECTRODE | Electrode quality** |
|---|---|
| E1 | B |
| EC-1 | A |

**A = good: smooth aspect, no evidence of agglomerates on the dried electrode, nor inhomogeneity due to bubbles formation and evaporation. Manual handling was easy, electrodes have good flexibility when slightly bended and folded, with no evidence of active material cracking or detachment.
B = medium: electrodes have an average homogeneous aspect. With accurate visual observation or with optical microscope, small agglomerates are detected. No material detachment nor cracking with gentle bending
C= bad: macroscopic inhomogeneity on the electrode surface (e.g. solid particles dragged during casting). Material cracked or detached from current collector without handling. Not possible to be punched/cut for further characterization

### Positive Electrodes Adhesion Evaluation

Positive electrodes (E1) and (EC-1) were cut in stripes (10 cm long and 2.5 cm wide) and applied onto rigid aluminium foils having thickness of 2 mm, using a biadhesive tape of dimensions 2.5×8 cm, with the coated side of the electrode facing the aluminium plate. A portion of the electrode was kept from adhering to the tape, thus leaving one end of each stripe not in contact with the biadhesive tape, allowing for its pulling from the foil.

Each specimen was pulled from the foil at an angle of 180° by a dynamometer that allowed the measurement of the force needed to peel off the sample from the biadhesive tape. Peeling speed is 300 mm/min, with T=25° C. The results are summarized in Table 4.

TABLE 4

| | Peeling Strength |
|---|---|
| | (N/m)**** |
| (E1) | 9.1 |
| (EC-1) | 1 |

****Normalized to EC-1

It has been demonstrated that the electrodes of the invention have an improved adhesion to metal foil in comparison with standard electrodes of the prior art comprising PVDF.

1. A positive electrode-forming composition (C) comprising:
a) at least one positive electrode active material (AM);
b) one binder (B), wherein binder (B) comprises:
i) at least one vinylidene fluoride (VDF) copolymer, polymer (F), that comprises:
(ia) recurring units derived from VDF;
(ib) optionally, recurring units derived from at least one hydrophilic vinyl monomer (MA) of formula (I): 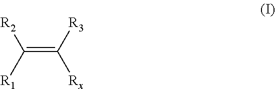
wherein:
R₁, R₂ and R₃, equal to or different from each other, are independently selected from a hydrogen atom and a C₁-C₃ hydrocarbon group, and
R_{X} is a C₁-C₂₀ hydrocarbon moiety comprising at least one functional group selected from a hydroxyl, a carboxyl, an epoxide, an ester, a phosphate, and an ether group,
in an amount of from 0.05 to 10% by moles of with respect to the total moles of recurring units of polymer (F);
ii) at least one polymer, polymer (A), derived from the polymerization of at least one monomer (I) and of at least one monomer (II), the said monomers corresponding to the following:
monomer (I): ethylenically unsaturated, linear or branched, aliphatic, cyclic or aromatic polycarboxylic acid, or anhydride,
monomer (II): ethylenically unsaturated, linear or branched aliphatic, cyclic or aromatic hydrocarbon;
c) at least one solvent (S); and
d) optionally at least one electroconductivity-imparting additive.

2. The composition (C) according to claim 1, wherein the hydrophilic vinyl monomer (MA) is selected from the group consisting of acrylic acid, methacrylic acid, hydroxyethyl (meth)acrylate, hydroxypropyl(meth)acrylate; and hydroxyethylhexyl(meth)acrylate.

3. The composition according to claim 1, wherein the active material (AM) is selected from lithium iron phosphate (LFP), lithium iron manganese phosphate (LMFP), and lithium manganese phosphate.

4. The composition (C) according to claim 1, wherein monomer (I) is a monomer of the following formula: 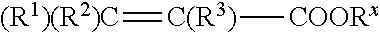
wherein the radicals R¹, R² and R³, which are identical or different, are selected from the group consisting of a hydrogen atom, a C₁-C₁₀ hydrocarbon radical optionally comprising a —COOH group, and a —COOH group, wherein at least one of R¹, R² and R³ is not a hydrogen atom;
R^{X} is selected from a hydrogen atom or a C₁-C₂₀ hydrocarbon moiety comprising at least one carboxyl functional group,
wherein the —COOH group of any of R¹ and R² can optionally be at least in part taken together with the group COOR^{X} to form an anhydride.

5. The composition (C) according to claim 4, wherein monomer (I) is selected from the group consisting of: citraconic, maleic, fumaric, or itaconic, acids, esters, or anhydrides; and (meth) acryloyloxyalkyl succinic acid.

6. The composition (C) according to claim 1, wherein monomer (II) is a monomer of the following formula: 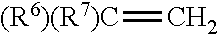
wherein the radicals R⁶ and R⁷, which are identical or different, are selected from the group consisting of a hydrogen atom and a linear or branched, aliphatic, or cyclic, saturated or ethylenically unsaturated C₁-C₁₀ radical.

7. The composition (C) according to claim 6, wherein monomer (II) is chosen from ethylene, propylene, 1-butene, isobutylene, n-1-pentene, 2-methyl-1-butene, n-1-hexene, 2-methyl-1-pentene, 4-methyl-1-pentene, 2-ethyl-1-butene, di-isobutylene (or 2,4,4-trimethyl-1-pentene), or 2-methyl-3,3-dimethyl-1-pentene.

8. The composition (C) according to claim 1, wherein polymer (A) is a copolymer of maleic anhydride and di-isobutylene monomer units.

9. The composition according to claim 8, wherein polymer (A) is at least partially salified.

10. The composition (C) according to claim 1, wherein the weight ratio of polymer (F) to polymer (A) in binder (B) is in the range of from 95:5 to 70:30.

11. A process for the manufacture of a positive electrode, electrode (E), said process comprising:
(i) providing a metal substrate having at least one surface;
(ii) providing an electrode-forming composition, composition (C), according to claim 1;
(iii) applying the composition (C) provided in step (ii) onto the at least one surface of the metal substrate provided in step (i), thereby providing an assembly comprising a metal substrate coated with said composition (C) onto the at least one surface;
(iv) drying the assembly provided in step (iii).

12. A positive electrode (E) obtained by the process according to claim 11.

13. A positive electrode (E), which comprises:
a metal substrate having at least one surface, and
directly adhered onto at least one surface of said metal substrate, at least one layer consisting of a composition, composition (C′), comprising:
a) at least one positive electrode active material (AM);
b) a binder composition, binder (B′), comprising:
b′) at least one vinylidene fluoride (VDF) copolymer, polymer (F), that comprises:
(i) recurring units derived from VDF;
(ii) recurring units derived from at least one hydrophilic (meth)acrylic monomer (MA) of formula (I): 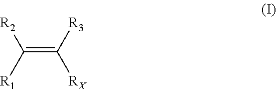
wherein:
R₁, R₂ and R₃, equal to or different from each other, are independently selected from a hydrogen atom and a C₁-C₃ hydrocarbon group, and
R_{X} is a C₁-C₂₀ hydrocarbon moiety comprising at least one functional group selected
from a hydroxyl, a carboxyl, an epoxide, an ester, a phosphate, and an ether group, in an amount of from 0.05 to 10% by moles of with respect to the total moles of recurring units of polymer (F);
b″) at least one polymer (A) derived from the polymerization of at least one monomer (I) and of at least one monomer (II), the said monomers corresponding to the following:
monomer (I): ethylenically unsaturated, linear or branched, aliphatic, cyclic or aromatic polycarboxylic acid, or anhydride,
monomer (II): ethylenically unsaturated, linear or branched aliphatic, cyclic or aromatic hydrocarbon monomer;
and
c) optionally at least one electroconductivity-imparting additive.

14. An electrochemical device comprising the positive electrode (E) according to claim 12.

15. The electrochemical device according claim 14 that is a lithium-ion secondary battery.

16. The composition (C) according to claim 6, wherein monomer (II) is diisobutylene.

17. The composition (C) according to claim 1, wherein the weight ratio of polymer (F) to polymer (A) in binder (B) is 90:10.
